(19) United States
(12) Patent Application Publication
(10) Pub. No.: US 2019/0301974 A1
(43) Pub. Date: Oct. 3, 2019

(54) Guide, Sensor Assembly, and Method

(71) Applicant: Robert Bosch GmbH, Stuttgart (DE)

(72) Inventors: Ahmad Mansour, Weil Der Stadt (DE); Lukas Lamprecht, Sinzheim (DE); Max Schellenberg, Ditzingen (DE); Ricardo Ehrenpfordt, Korntal-Muenchingen (DE)

(21) Appl. No.: 16/360,253

(22) Filed: Mar. 21, 2019

(30) Foreign Application Priority Data
Mar. 27, 2018 (DE) 10 2018 204 648.4

(51) Int. Cl. G01M 13/045; F16C 29/06; F16C 19/52

(52) U.S. Cl. CPC G01M 13/045; F16C 19/527; F16C 29/0633

(57) ABSTRACT

According to the disclosure, a sensor assembly, in particular for a guide, is provided, which has a sensor and an analysis device. The analysis device determines a movement profile of the guide component based on a vibration signal detected by the sensor, wherein a part of the movement profile is used for the fatigue detection. Alternatively or additionally, it can be provided that the vibration signal detected by the sensor is filtered or digitally filtered and the or a movement profile of the guide component is determined based on the filtered or digitally filtered signal.

This application claims priority under 35 U.S.C. § 119 to application no. DE 10 2018 204 648.4, filed on Mar. 27, 2018 in Germany, the disclosure of which is incorporated herein by reference in its entirety.

### TECHNICAL FIELD

The disclosure relates to a guide, in particular a linear guide or rotary guide. Furthermore, the disclosure relates to a sensor assembly for a guide and a method using a guide.

### BACKGROUND

Monitoring fatigues, for example a material fatigue, of linear guides using sensors is known from the prior art. For example, a linear roller bearing is monitored via a vibration sensor in DE 11 2005 002 077 T5. In DE 10 2015 201 121 A1, monitoring of a linear movement device having at least one row of roller bodies is carried out by tapping a structure-borne noise vibration.

### SUMMARY

In contrast, the disclosure is based on the object of providing a guide, which can be reliably monitored using a simple device. Moreover, a sensor assembly is to be provided, using which reliable monitoring, for example of a guide, is enabled using a simple device. Moreover, it is the object of the disclosure to provide a method using a guide, using which reliable monitoring of the guide is enabled in a simple manner.

The object is achieved with respect to the guide according to the disclosure, with respect to the sensor assembly according to the disclosure, and with respect to the method according to the disclosure.

Advantageous refinements of the disclosure are the subject matter of the detailed embodiments.

According to the disclosure, a guide or linear guide or rotary guide is provided, wherein the guide comprises a guide part and a guide component. The guide component is guided on the guide part in this case and is movable in relation thereto. The guide part is, for example, a guide rail or a guide spindle. The guide component can be, for example, a ballscrew nut or a guide carriage. A sensor is advantageously provided in the case of the guide component to detect a vibration signal or a vibration. Furthermore, an analysis device is advantageously provided in the case of the guide component for analyzing the vibration signal detected by the sensor or the data determined by the sensor. A movement profile of the guide component can advantageously be determined, in particular by the analysis device, based on the vibration signal detected by the sensor. Furthermore, the vibration signal of a part of the movement profile can advantageously be used for fatigue detection and/or detection of the lubrication state and/or detection of the installation quality, which advantageously results in a saving of computing capacity during the fatigue detection, since the entire movement profile is not analyzed. Alternatively or additionally, it can be provided that the vibration signal detected by the sensor is digitally filtered, in particular by the analysis device. The or a movement profile of the guide component can then be determined based on the digitally filtered signal, which also results in a saving of computing capacity.

A fatigue detection can thus be carried out by the guide according to the disclosure with comparatively low computing effort. Due to the low computing effort, comparatively little energy is necessary for the analysis device. The analysis device can therefore, for example, be designed as smaller or can be supplied via energy sources which are designed as small and/or provide comparatively little energy. The device expenditure of the guide thus sinks. Wear of the guide and/or the guide component can be detected using the sensor, for example, and targeted, predictive maintenance can be carried out, for example, with little computing expenditure on the basis of the data analysis, whereby unplanned standstills can be reduced in a simple manner. The fatigue detection according to the disclosure is extremely advantageously usable in the guide or the guide component, since a prediction accuracy and prediction reliability of the fatigue detection is significantly more complex therein than, for example, in the case of a radial bearing, and therefore a reduced computing expenditure results in a substantial advantage. If the guide is used, for example, in a machine tool, the vibration signal can thus be based on a variety of influences, for example on the installation of the components, on operating parameters, for example feed rate, on a speed, on acting forces, on accelerations, on loads, on particles, and appearances of aging. In the guide according to the disclosure, due to the low computing expenditure, the computing operations are therefore not necessarily to be carried out externally, for example via the Internet or via a cloud, but rather can be provided autonomously with low device expenditure by the analysis device in the case of the guide component. Due to the simplified design and the lower required energy of the analysis device, it can advantageously also be used with a low installation space requirement, which is extremely advantageous in guides, since a comparatively small installation space is typically available here.

In a further embodiment of the disclosure, a frequency band of the vibration signal or a frequency band of the vibration signal of a part of the movement profile can be determined, in particular by the analysis device. The frequency band can then be used for the fatigue detection by the analysis device. The entire spectrum of the vibration signal is thus not used for the fatigue detection, but rather only a frequency band, which saves computing power. The frequency band is advantageously determined as a function of a velocity of the guide component. The frequency band necessary for the fatigue detection can thus be estimated and/or taken from a database on the basis of the computed velocity and can be purged of the frequency bands which are not needed by filtering. A computation of the entire spectrum is thus no longer necessary due to the filtering. Due to the reference to the computed velocity, it is possible to compute the frequency band necessary for the fatigue detection in a simple manner. The signal analysis and/or the fatigue detection can then only still be carried out in this frequency band. The amount of data for the analysis device and thus the required computing expenditure can be substantially reduced further in this way. Rapid changes, so-called harmonics, can then be filtered out by the determined frequency band and thus slow, continuous changes, which occur in the event of continuous fatigue, can be detected in a targeted manner in the signal analysis or fatigue detection. It is therefore not necessary to compute theoretical damage frequencies over discrete modes in the spectrum of the vibration signal, which would result in inadequate results in the fatigue detection because of the variety of influences in the case of a guide.

In a further embodiment of the disclosure, the digital filtering is carried out in such a way that at least a part of the movement profiles or all movement profiles of the guide component can be determined and/or delimited from one another. The fatigue detection or state detection can then advantageously be carried out only for a part of the movement profile, as already stated above. The digital filtering is preferably carried out via a low-pass filter. This has the advantage that the recognition of the acceleration profile is carried out at low frequencies, since a more reliable recognition of and/or ability to delimit the parts of the movement profile is enabled in this case. The high filtered-out frequencies are more suitable for a later fatigue detection and/or can also be taken into consideration during a later fatigue detection. In other words, a recognition of various profiles of the movement can be carried out by the digital filtering. With the aid of the low-pass filter, the different movement profiles can be extracted from the raw signal or vibration signal and detected. Alternatively or additionally to the digital filtering via a low-pass filter, digital filtering can be carried out via a discrete wavelet transformation (DTW). For this purpose, for example, the recognition of the different parts of the movement profiles or acceleration profiles can be carried out in parallel in various frequency bands.

One or more of the following movement profiles of the guide component can preferably be determined via the analysis device: a standstill profile, in which the guide component is stationary; a starting profile, in which the guide component is set into motion from a standstill; an acceleration profile, in which the velocity of the guide component is increased; a profile of constant velocity, in which the guide component is moved at a constant velocity; a braking profile, in which the guide component is decelerated, in particular to a standstill. The determination of the different movement profiles has the advantage, as already stated above, that the fatigue recognition or fatigue detection can be carried out only in one determined movement profile or multiple determined movement profiles. Thus, for example, to avoid undesired acceleration influences, the fatigue detection is carried out in the profile of constant velocity. Furthermore, it is advantageous if the fatigue detection is independent of varying operating parameters, for example a feed velocity, the variation of which would significantly change occurring vibrations and would continuously shift fixed detection thresholds, and of environmental disturbances. The achieved velocity of the guide component can then advantageously be computed in the following profile of the constant velocity on the basis of the vibration signal in the starting profile and/or acceleration profile. In particular, a strength and duration of the acceleration can be determined, for example by the area below an acceleration curve. With the determination of the velocity, characteristics determined in the fatigue detection can then advantageously be referenced and/or scaled to the velocity without interference. It is therefore possible to avoid different velocities of the guide components, which would result in varying vibrations, reduce a prediction accuracy of the fatigue detection and result in flawed predictions.

As already stated above, the analysis device can preferably carry out the fatigue detection in the movement profile of the constant velocity.

As already stated, the velocity of the guide component can furthermore advantageously be determined by the analysis device and taken into consideration in the fatigue detection. The velocity is preferably determined on the basis of or with reference to the vibration signal. Furthermore, the determination of the velocity is preferably carried out in the starting profile and/or in the acceleration profile.

In a further embodiment of the disclosure, it can be provided that the vibration signal or acceleration sensor raw signal is measured in the time range. The measurement via the sensor is preferably carried out in the frequency range up to 20 kHz, in particular in the frequency range up to 1 kHz. The measurement via the sensor can start as a result of a predetermined event, whereby the sensor is not continuously in operation in an advantageous and energy-saving manner. The sensor measurement can also be ended after at least one pre-determinable condition, for example after a predetermined period of time and/or after a measurement. For example, the measurement of the sensor can be triggered or initiated by a rising flank in a vibration signal. The sensor can recognize a beginning and/or an end of the movement of the guide component, for example by establishing a configurable acceleration threshold for the beginning and/or the end. If the acceleration increases beyond the established acceleration threshold, the measurement of the sensor can thus begin, and/or if the acceleration falls below the predetermined acceleration threshold or a further predetermined acceleration threshold, the measurement can thus be ended. Alternatively or additionally, it is conceivable that a measurement cycle is set via a counter function and/or time function. A measurement can thus be carried out, for example, at determined times. Alternatively or additionally, it can be provided that triggering or initiation of a measurement of the sensor is carried out by an external or externally-controlled activation, for example by a facility controller or a gateway by way of an electric signal.

In one preferred embodiment, carrying out the computation of the velocity on the basis of discrete drive modes can be provided, for example for additional verification of the velocity computed in the time signal or in the mentioned movement profiles. However, this requires computing effort, since computation is carried out for this purpose in a spectrum and not in the time signal. A provision of the velocity, for example via the controller of the drive motor, in particular via a trigger signal, is alternatively or additionally also conceivable. However, this results in additional expenditure in the application of the sensor system, since control commands have to be implemented on the hardware side.

In a further embodiment of the disclosure, one or more correction factor(s) can advantageously be determined in addition by the analysis device, in order to remove interference, for example frequency modes of adjacent assemblies, from the fatigue detection. The correction factors can be based, for example, in particular within the movement profiles, on environmental conditions, for example temperature and/or background vibrations and/or background noise.

A temperature sensor is preferably additionally provided, in particular in the case of the guide component, to take into consideration a temperature. This sensor can be connected to the analysis device. A microphone, which is designed in particular as a micro-electromechanical system (MEMS) can advantageously be provided easily, in particular in the case of the guide component, for the detection of background noises. This microphone is preferably connected to the analysis device. To detect background vibrations, it can advantageously be provided that the sensor at least temporarily continues to detect a vibration signal after the end of the movement profile, i.e., for example, upon stopping of the guide component, or outside the movement profile. In other words, background vibrations can be detected in such a manner that the sensor system has a measurement duration which lasts at least somewhat beyond the end of the travel. Background vibrations can thus be detected and incorporated during the stopping phase of the guide component in each measurement cycle. In other words, background vibrations can be determined during the standstill profile of the guide component by the analysis device via the sensor.

In a further embodiment of the disclosure, the analysis device can determine one or more characteristic(s) in the determined frequency band and/or in the vibration signal and/or in the vibration signal of a part of the movement profile. A fatigue detection or damage detection can then advantageously be carried out on the basis of these characteristics. The characteristic or the characteristics is/are preferably selected from the following characteristics: mean value; mean absolute bias (MAB); root mean square (RMS). In particular the root mean square has a low computing effort. However, the other characteristics also have a comparatively low computing effort.

In one preferred embodiment of the disclosure, multiple measurements can be taken into consideration by the analysis device in a part of the characteristics or a respective characteristic. Furthermore, the characteristic or the respective characteristic can be averaged over the measurements. An additional averaging of one or more characteristics advantageously reduces the effect of spontaneous interference. The characteristics can be computed as follows for a sensor signal X having N measurements or samples:

$${X}_{f } = X * h$$

$${X}_{ab s} = \vert {X}_{f} \vert$$

$$\overline{x} = \frac{1}{N} {\sum }_{i = 1}^{N} {X}_{ab s} ( i )$$

$${x}_{rm s} = \frac{1}{N} \sqrt{{\sum }_{i = 1}^{N} {X}_{ab s}^{2} ( i )}$$

$${x}_{m ad} = \frac{1}{N} {\sum }_{i = 1}^{N} \vert {X}_{ab s} ( i ) - \overline{x} \vert$$

X_{f} is the filtered signal, h is the transmission function of the filter, X_{abs} is the absolute value of X_{f}, x̅ is the mean value, xᵣₘₛ is the root mean square, and x_{mad} is the MAD (middle absolute deviation) value or MAB value.

In a further embodiment of the disclosure, it can be provided that the determined or computed characteristic or the determined or computed characteristics is/are scaled using the computed or determined velocity, in particular the velocity in the constant velocity profile, via the analysis device. A compensation of effects of different velocities on the characteristics and/or on the fatigue detection can advantageously be compensated for in this way. Additionally or alternatively, it can be provided that the determined characteristic or the determined characteristics is/are corrected using one or more computed correction factor(s) via the analysis device. For example, a jump due to background vibrations can be compensated for as a correction factor.

The determined characteristic or the determined characteristics can preferably be stored on a memory, in particular of the guide component or of a or the microcontroller or the analysis device. A comparison of stored characteristics to newly determined characteristics can thus be carried out in a simple manner, in order to carry out a fatigue detection.

In the case of multiple determined different types of characteristics, they can preferably be combined by the analysis device to advantageously reduce a computing effort. Multivariate or multidimensional distributions are advantageously constructed for the combination of the characteristics, in particular a mean value vector or a covariance matrix. In the case of multiple determined different types of characteristics, the analysis device can analyze them or a part thereof in parallel and/or analyze them by way of a linear combination. In other words, the analysis can be carried out in parallel in single dimensions or characteristics or by a linear combination of the characteristics. The following formula can be used for the combination of the characteristics:

F=a₁F₁+a₂F₂+ . . . +aₘFₘ

In this case, aᵢ can be the weighting factor for the respective characteristic Fᵢ, wherein F can then be used as a characteristic for the analysis or the fatigue detection. In other words, a weighting factor can be associated with each of these characteristics in the combination of characteristics. The characteristics are simply added up, for example.

In a further embodiment of the disclosure, the determined characteristic, in particular the present determined characteristic, or the determined characteristics, in particular the present determined characteristics, can be compared to the corresponding stored characteristics by the analysis device. In this way, the analysis device can then conclude a change of the characteristics and draw conclusions. For example, in the case of a comparison of the characteristics, the analysis device can differentiate between a reduction and/or an increase and/or a non-change of the characteristic or characteristics.

In other words, a slope of the characteristic values or the characteristics and/or the combined characteristic values or combined characteristics can be progressively computed in comparison to the preceding characteristics or the preceding combined characteristics. It is thus conceivable, for example, to store the combined characteristics alternatively or additionally to the individual characteristics or to the individual characteristic.

If a change or a slope of the characteristic or the studied characteristics or the combined characteristic is less than or equal to 0, the analysis device can conclude therefrom that no fatigue exists. The guide can thus be in a running-in phase or a stable phase. In the case of a reduction of the slope, a running-in phase of the guide can be presumed. If the slope is less than 0, for example, roller bodies and/or guide paths can settle due to running in. Energies in the spectrum can decrease in this case and vibrations can be reduced. The stable phase follows the running-in phase. An installation check can be performed on the basis of the energetic level of the starting point of the running-in phase. A system installed with tension deviates significantly from a correctly installed system. It can thus be established that the analysis device can be established, on the basis of the dimension of the characteristic or the characteristics or the combined characteristic at the starting time of the use of the guide component by comparison to a reference value, whether the guide is correctly installed.

In a further embodiment of the disclosure, the analysis device can presume a non-change of the characteristic(s) or the combined characteristic if it is or they are below an upper limit and/or above a lower limit and/or between two limits. In other words, in the case of a slope of, in particular approximately, 0, it can be presumed that the guide is in a stable phase. There are then hardly any changes in the detected vibration signal, for example. The stable phase generally occupies the predominant part of the service life of the system. Within the stable phase, all new characteristics can be incorporated continuously into the computation of the limit formation, for example via control charts, in particular using 3σ, of the stable phase and continuously update them. In other words, in the case of a non-change of a characteristic or of characteristics or of the combined characteristic, the analysis device can preferably also incorporate it or them with respect to a computation of the limit or the limits. The limits or the limit can thus be adaptively adjusted. In other words, the analysis device can check whether the characteristic(s) is/are above or below a limit or upper limit, and/or whether the characteristic(s) is/are below or above a limit or lower limit, and/or whether the characteristic(s) is/are between two limits. The characteristic or the characteristics can then be used by the analysis device in a computation of the limit or the limits, whereby the limit or the limits is/are adaptively adjustable.

In a further embodiment of the disclosure, the analysis device can presume an increase of the characteristic(s) or the combined characteristic if it is or they are above the limit or the limits. If a slope, in particular of the characteristics scaled to the velocity, is thus continuously greater than 0 for a sequence of multiple measurements, a fatigue is possible. The analysis device can then carry out one or more outlier tests in the case of an increase of the characteristic(s) or the combined characteristic. Disturbances can be recognized and filtered out by outlier tests, for example a sudden short-term increase of characteristics.

In a further embodiment of the disclosure, it can be provided that the analysis device can output different warnings in the event of an increase of the characteristic(s) or the combined characteristic. For example, if the characteristic(s) or the combined characteristic exceeds the limit, in particular the upper limit, a warning, in particular a first warning, or warning level 1 can be output. Leaving the computed limits of the stable phase (greater than 5σ) can thus be indicated by the warning level 1. A further warning can be provided if exceeding of a value of the characteristic(s) or the combined characteristic in relation to the maximum value of the corresponding characteristic or the corresponding characteristics takes place in a running-in phase of the guide component or at the beginning of the recordings of the guide component, wherein a warning, in particular a second warning, or warning level 2 can then be output. In other words, the warning level 2 can be initiated upon exceeding the energetic level of the fixed point of the running-in phase. If no running-in phase is provided, for example if the sensor was retrofitted, instead of the warning level 1, warning level 2 can then be output directly. In a further embodiment of the disclosure, an alarm or a warning, in particular a third warning, or warning level 3 can be output by the analysis device if one or more conditions are met, which is/are selected from the following conditions: after warning level 2, a predetermined number of cycles is reached, wherein the number of the movement cycles of the guide component or the measurement cycles of the analysis device can be provided as the number of cycles; an estimated remaining service life, in particular of the guide component, is reached; one or more characteristics exceed a determined statistical limit (n×σ); an absolute or configurable limit or threshold value for the characteristic or the characteristics or a part of the characteristics is reached.

In a further embodiment of the disclosure, the route of the guide component can advantageously be determined by the analysis device. In other words, the analysis device can carry out the analysis in a location-resolved manner Therefore, in order to monitor not only the moving guide component but rather also the guide part in the fatigue detection, it can be advantageous to measure the route, in particular the entire route, and to carry out the analysis in a location-resolved manner. In this way, for example, damage to the guide part can be detected and assigned in a location-resolved manner. If the guide component is defective, this thus typically results in increasing characteristics, wherein this takes place constantly over the full complete travel or over the entire route. If the guide part is defective, the determined characteristics thus have position-dependent slopes within the travel or the route. In the event of a defective drive motor or, for example, a defective spindle bearing, the characteristics display a continuous increase during a movement and approach of the guide component toward the drive motor.

Alternatively or additionally, it is conceivable to carry out the fatigue detection during a reference travel, which is defined in particular. This has the result that the velocity or the linear velocity and the frequency range are known. There are then fewer interference sources due to background signals. Moreover, the characteristics are subject to fewer variations and do not have to be scaled to velocities.

An energy generating unit is preferably provided in the guide component for supplying a part of the electronic components or all electronic components of the guide component. The energy generating unit is advantageously designed in this case in such a way that it generates energy during a relative movement between the guide part and the guide component. Since the analysis device has a low computing power because of the comparatively simple computing operations and therefore has a comparatively low energy consumption, it can readily be supplied autonomously via the energy generating unit.

So-called “energy harvesting” can be used, for example, for obtaining energy. Furthermore, it is conceivable to provide an energy store, which can be charged, in particular via the energy generating unit. It would also be conceivable to additionally or alternatively charge the energy store externally if needed. The energy store can then be provided for supplying a part or all electronic components of the guide component, in particular for those electronic components which are responsible for the fatigue detection.

The analysis device preferably analyzes the data detected by the sensor autonomously.

The sensor is an acceleration sensor or vibration sensor, for example, as a simple device. The sensor is preferably designed as a micro-electromechanical system (MEMS). The sensor preferably measures vibration signals in the frequency range from 0 to 20 kHz, furthermore preferably between 0 to 3 kHz, furthermore preferably between 0 to 1 kHz. The sensor is designed, for example, as a 3-axis acceleration sensor, in particular having capacitive measuring principle. Providing a plurality of sensors is conceivable.

The analysis device preferably has analysis software. Furthermore, it is conceivable that the analysis device has a processor and/or is designed as a microcontroller. The microcontroller can have, for example, at least one periphery function. Furthermore, the analysis device can have an operating and/or program memory, which can be part of the microcontroller. The analysis device can also be designed as a MEMS or form a MEMS together with the sensor. Improving the functional scope of the guide by free capacities of the analysis device and/or a comparatively small number of memory modules and/or energy-autonomous and/or wireless fatigue detection, in particular on the basis of primary or secondary cells with energy harvesting, is enabled according to the disclosure.

In a further preferred embodiment of the disclosure, a data transmission device or communication device can be provided, in particular in the case of the guide component. It is conceivable that it is part of the MEMS or microcontroller. Data of the analysis device and/or the sensor can be transmitted to an external communication device, preferably wirelessly, using the communication device. The external communication device can be part of a machine controller or can provide an interface to the Internet or to a cloud. The result of the analysis device is preferably transmitted using the most minimal possible amount of data via the communication device. For example, only one bit can be provided, wherein then the information can be output as to whether a fatigue is present or not. In other words, it is advantageous if exclusively a few numeric values or characteristics, but in particular only the result of the fatigue detection (fatigue yes/no) and/or remaining service life to be expected and/or required actions, are transmitted per travel of the guide component.

An electronics unit is preferably provided in the guide component, which can convert analog sensor signals into digital signals. Moreover, it is conceivable that the electronics unit provides a serial bus, such as I²C or SPI.

The autonomous energy supply, in particular of the analysis device and/or the sensor, has the advantage that no batteries or accumulators are necessary. Systems which only have a battery or an accumulator for the energy supply typically have an energetic service life of 2 to 5 years. A battery change is thus disadvantageously required in such systems at regular intervals, which causes costs and results in an environmental strain. In a variety of sensors, such systems would practically not be usable. An autonomous fatigue detection can thus be carried out using the system according to the disclosure, wherein no maintenance is required for the components.

In a further embodiment of the disclosure, the components for the fatigue detection, in particular the sensor, analysis device, energy supply, etc., can be designed as a module. Such a module is easily installable and can also be easily retrofitted, for example.

The guide component is advantageously a threaded nut or a ballscrew nut. The guide part can then be a spindle or guide spindle. A housing can be fixed on the ballscrew nut, which has the sensor and/or the analysis device and/or one or more of the above-mentioned electronic components. The housing can be axially arranged on the ballscrew nut viewed in the direction of the guide spindle. The ballscrew nut preferably has a flange, from which the nut body extends in a first axial direction and the housing can extend in the opposite direction. The housing preferably has an outer lateral surface viewed in the radial direction, which preferably extends at least in sections along a circular cylinder, wherein a longitudinal axis of the circular cylinder can extend coaxially or in parallel spacing to the longitudinal axis of the guide spindle. A diameter of the housing is preferably less than or equal to a maximum diameter of the ballscrew nut in this case. In a further embodiment of the disclosure, the housing encloses the guide spindle only in sections. In particular, the housing is designed as approximately U-shaped on sides of the guide spindle. A circular segment angle of the housing is, for example, at most 180°. The housing can thus be easily retrofitted, by not exceeding a circular segment angle which enables the housing to be arranged over the guide spindle during the installation and to enclose it. It would also be conceivable to design the housing in multiple parts, which can then enclose the guide spindle, and it is easily installable due to the multipart design. For example, the housing is connected via fastening means to the ballscrew nut, in particular to the flange of the ballscrew nut, with respect to easy retrofitting capability or easy installation. An adapter can also be provided between the housing and the ballscrew nut, whereby screw points or fastening points can be arranged and designed flexibly.

In one preferred embodiment of the disclosure, it can be provided that the guide component is a guide carriage and the guide part is a guide rail. For example, the guide carriage is roller-body-mounted. In other words, the guide can be designed as a profile rail guide. A housing according to one or more of the above aspects can be provided on the guide carriage. For example, the housing is arranged on a side of the guide carriage facing in the longitudinal direction. Furthermore, the housing preferably does not exceed external dimensions of the outer contour—in particular viewed in a plane transverse to the guide rail—of the guide carriage. The housing is designed as approximately U-shaped, for example, and can thus easily enclose the guide rail. It would also be conceivable to design the housing in multiple parts with respect to easy retrofitting capability.

In addition to the described sensor, it is conceivable to provide one or more further sensors. Thus, for example, an optical sensor system and/or an ultrasound sensor system can be provided for detection of an oil film thickness and/or the lubrication quality and/or a lubricant turbidity and/or of particles. A detection axis of the additional sensor or the additional sensors is preferably oriented in the direction of the surface of the guide part, in particular in the direction of the surface of the guide spindle or the guide rail. As already explained above, it is conceivable to provide a sound-based sensor system, in particular a microphone, for detection of background noises as an additional sensor system. Moreover, a temperature sensor system can be provided.

According to the disclosure, a sensor assembly is provided, which has a sensor for detecting a vibration signal. Furthermore, an analysis device can be provided in the sensor assembly for analyzing the vibration signal detected by the sensor. A movement profile of the guide component can then be determined based on the vibration signal detected by the sensor and the vibration signal of at least a part of the movement profile can then be used for the fatigue detection. Alternatively or additionally, it is conceivable that the vibration signal detected by the sensor is digitally filtered and the or a movement profile of the guide component is determined based on the digitally filtered signal.

The sensor assembly can be designed according to the above aspects.

According to the disclosure, a method using a guide according to one or more of the preceding aspects or using a sensor assembly according to one or more of the preceding aspects is provided, which has the following steps:
determining a movement profile based on the vibration signal detected by the sensor, wherein preferably the vibration signal of a part of the movement profile is used for the fatigue detection,
and/or digital filtering of the vibration signal detected by the sensor, wherein the or a movement profile of the guide component is determined, for example, based on the digitally filtered vibration signal,
and/or determining a frequency band of the vibration signal detected by the sensor, wherein the frequency band is used for the fatigue detection by the analysis device.

Furthermore, the method can have one or more of the above-mentioned aspects.

In other words, a fatigue detection sensor for linear drives and linear guides is provided, which is provided in particular for the detection of mechanical fatigues of the linear guide. A velocity-dependent scaling or characteristic correction can be used in this case, which enables the detection of the fatigues in running operation without reference path. Alternatively or additionally, an integrated phase recognition can be provided, which detects a running-in phase, a stable phase, and a fatigue phase and incorporates them into the analysis. Limits of the stable phase can be continuously adjusted and adapted or readjusted. Fixed threshold values are thus not required, which results in adaptive fatigue detection. It can be established in particular in the fatigue detection whether a continuous slope of relevant characteristics and/or leaving of computed limits of the stable phase and/or exceeding of the energetic level of the starting point of the running-in phase is/are present. Furthermore, it can be established whether a limiting value, such as maximum number of cycles after leaving the limits of the stable phase and/or an estimated remaining service life and/or characteristics greater than n×σ are achieved and/or an absolute or configurable threshold value is reached.

In other words, according to the disclosure complete self-adapting fatigue detection or signal processing and signal analysis close to the sensor can be provided on a microcontroller highly integrated into the sensor system. The fatigue detection can provide in this case a signal detection and/or measurement and/or an acceleration profile recognition and/or a parameter estimation and/or filtering and/or computation of characteristics and/or a slope computation.

In other words, using the guide and/or using the method and/or using the sensor arrangement, an analysis or fatigue detection can be carried out in running operation, for example of a linear roller bearing, and not only during a special measuring travel. The vibration signal is advantageously digitally filtered. Phases of constant velocity, in particular general stationary operating conditions, can then be recognized from the filtered signal. The analysis can primarily take place in these phases. Items of information from the other phases can be used to assist the analysis, for example by determining a velocity from the other phases.

In other words, the analysis device can be attached directly to the rotor of the linear roller bearing. Due to the design according to the disclosure, it is constructed very compactly and manages with little electrical supply power. The movement of the linear roller bearing can be utilized to supply the analysis device with energy. It is sufficient to design the corresponding microcontroller as comparatively low-performance. The analysis method is designed as simply as possible so that it is executable by the microcontroller. Nonetheless, it has reliable recognition of damage. An analysis in the frequency range is not necessary. The analysis device advantageously manages using data which it determines itself. It is advantageously not connected to a higher-order controller. The possibility of determining the travel velocity is also advantageous. This can be determined by integration of the signal of an acceleration sensor. The vibration signals determined by the acceleration sensor can be substantially dependent on the travel velocity.

### BRIEF DESCRIPTION OF THE DRAWINGS

Preferred exemplary embodiments of the disclosure will be explained in greater detail hereafter on the basis of schematic drawings. In the figures:

FIG. 1a shows a perspective illustration of a guide according to one exemplary embodiment,

FIG. 1b shows the guide from FIG. 1a in a side view,

FIG. 2a shows a perspective illustration of a part of a guide together with a sensor assembly,

FIG. 2b shows a perspective illustration of a guide according to a further exemplary embodiment,

FIG. 3 shows a flow chart of a functional description of the guide according to the exemplary embodiments,

FIG. 4 shows a vibration signal detectable via a sensor of the guide according to the exemplary embodiments,

FIG. 5 shows a diagram of a starting and acceleration phase of the guide for different velocities,

FIG. 6 shows a diagram of analysis results of a fatigue detection of the guide, and

FIG. 7 shows the diagram from FIG. 6 with warning limits indicated.

### DETAILED DESCRIPTION

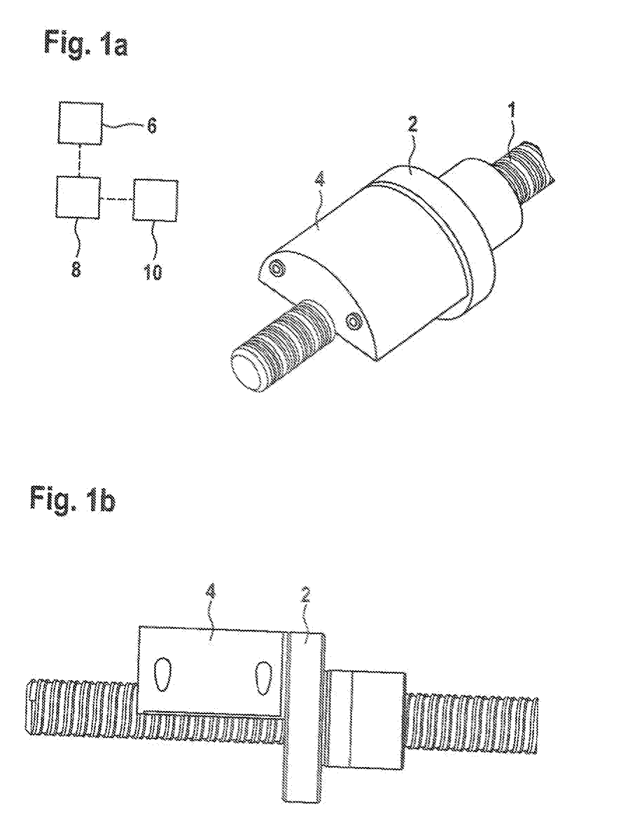

According to FIG. 1a, a guide according to one exemplary embodiment has a guide part in the form of a guide spindle 1 and a guide component in the form of a ballscrew nut 2. A housing 4 is fastened on a flange of the ballscrew nut 2 on an end face facing in the axial direction. A sensor 6 is provided in this housing, which is schematically shown in FIG. 1a. A vibration signal of the guide can be detected using this sensor. Furthermore, an analysis device 8 in the form of a microcontroller is provided, which is also schematically shown in FIG. 1a and is connected to the sensor 6. Furthermore, the analysis device 8 is connected to an energy generating unit 10, wherein this is also schematically shown. It is recognizable according to FIGS. 1a and 1b that the housing 4 is designed in a shell shape and the diameter corresponds to that of the ballscrew nut 2. The shell-shaped housing 4 encloses the guide spindle 1 in this case.

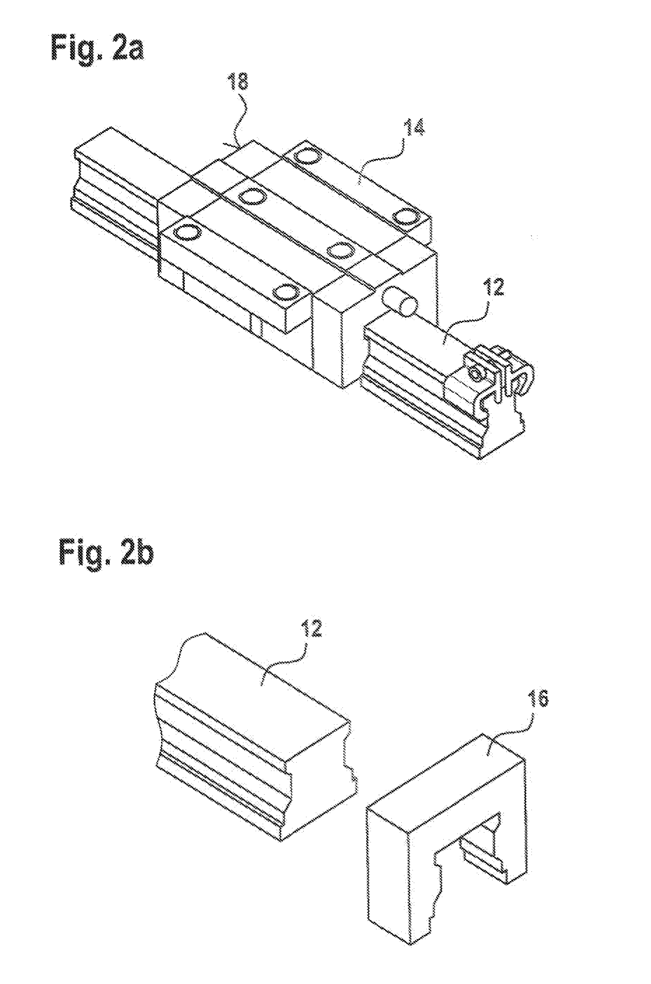

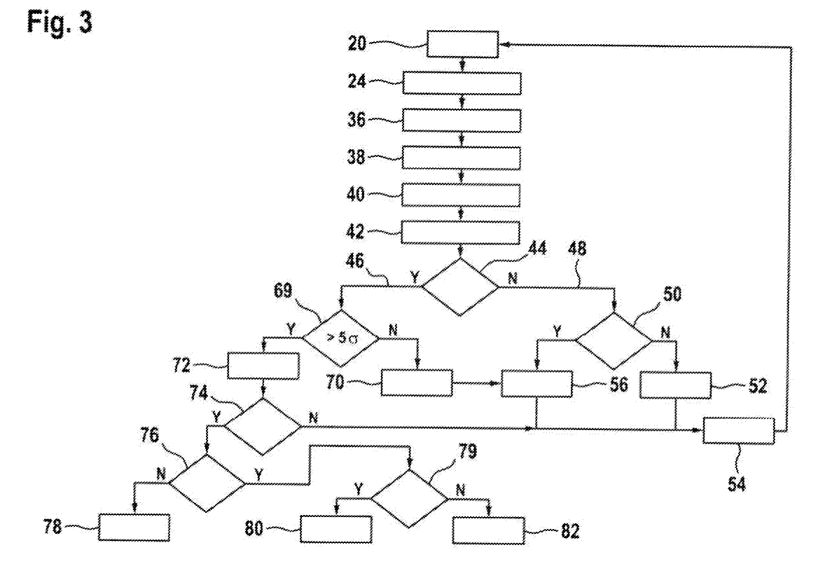

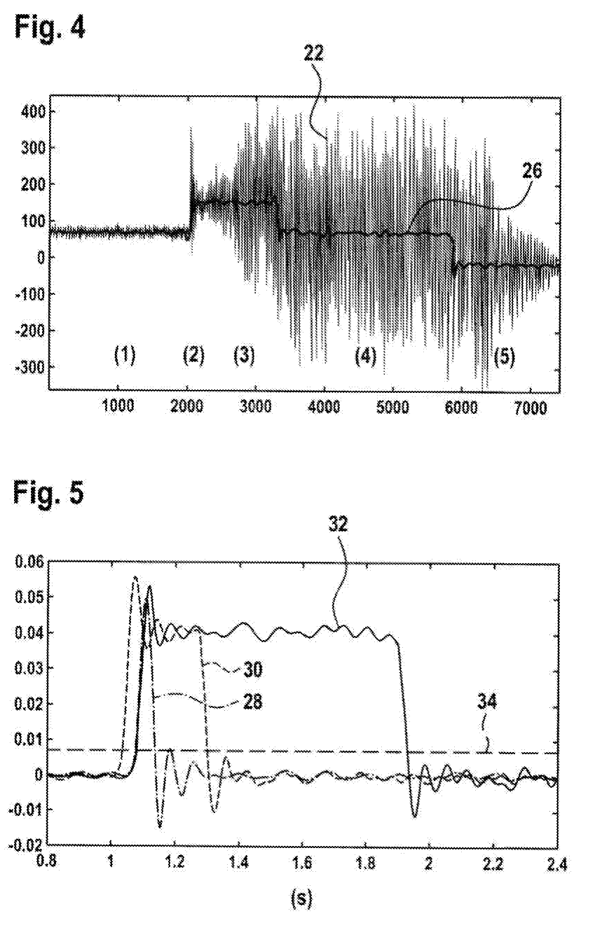

According to FIGS. 2a and 2b, a further embodiment of a guide having a guide part in the form of a guide rail 12 and a guide component in the form of a guide carriage 14 is provided. A housing 16 is designed U-shaped in this case and in particular has a sensor, an analysis device, and an energy generating unit corresponding to FIG. 1a. The housing 16 can be fastened on an end face 18 of the guide carriage 14 facing in the axial direction. In the radial direction, the housing 16 does not protrude beyond the guide carriage 14 in this case. Due to the U-shaped design of the housing 16, it can advantageously enclose the guide rail 12. If the guide rail 12 has a profile, corresponding to FIG. 2a, the housing 16 can thus engage in the profile with a corresponding profile. According to the flow chart in FIG. 3a, a measurement 20 is identified with a first block. During the measurement, a vibration signal is detected by the sensor 6, see FIG. 1a. This is apparent in FIG. 4 and is provided with the reference sign 22. The vibration signal 22 is plotted in a diagram, wherein the abscissa shows the number of the measurements and the ordinate shows a scaled amplitude of the vibration signal 22. According to FIG. 3, after the measurement 22, a determination of a movement profile is carried out based on the vibration signal 22 in the block 24. For this purpose, the vibration signal 22 is digitally filtered via a low-pass filter, whereby a movement profile 26 is recognizable according to FIG. 4. This profile has multiple parts. According to FIG. 4, a standstill profile is shown by the number 1, a starting profile is shown by the number 2, an acceleration profile is shown by the number 3, a profile of constant velocity is shown by the number 4, and a braking profile is shown by the number 5. The fatigue detection is carried out in particular in the profile having the constant velocity to avoid undesired acceleration influences, because of which it is extremely advantageous to detect the different parts of the movement profile by way of the analysis device 8, see FIG. 1a. The velocity of the ballscrew nut 2 or the guide carriage 14, respectively, see FIGS. 1a and 2b, is determined in the profile of constant velocity on the basis of the standstill profile and/or the starting profile. This is explained in greater detail in FIG. 5. The starting and acceleration phase of the linear movement is shown therein by different achieved velocities of the phase having the constant velocity. A time in seconds is plotted on an abscissa in this case and an amplitude is plotted on an ordinate. A curve 28 shows in this case the starting and acceleration phase in the case of a revolution of a drive motor at 50 RPM. A further curve 30 shows the starting and acceleration phase in this case at 300 RPM and a curve 32 shows the starting and acceleration phase at 1000 RPM. The computation of the velocity is preferably performed using the sections of the curves 28, 30, or 32 which are above a threshold value 34.

According to FIG. 3, a block 36, in which a frequency band of the vibration signal 22 is determined, follows after the block 24, wherein the frequency band is used for the fatigue detection by the analysis device 8, see FIG. 1a. The frequency band is estimated on the basis of the computed velocity and is purged of the frequency bands which are not required by filters, see block 38 in FIG. 3.

A computation of relevant characteristics of the frequency band worked out in the block 38 is carried out in the following block 40 in FIG. 3. A mean value or an MAD or RMS value can be provided as characteristics, for example. After the block 40, a block 42 can be provided, in which a scaling of the computed characteristics to the computed velocities is provided, so that effects of different velocities can be compensated for. A signal analysis subsequently follows in the block 44. For this purpose, the determined characteristics are combined, as explained at the outset, and the combined characteristic is compared to previously determined characteristics. If a slope of the characteristic or an increase of the characteristic greater than 0 is provided, the method according to FIG. 3 having the left branch 46 is thus provided. If the characteristic remains equal or decreases, the method thus continues according to FIG. 3 with the right branch 48. In the branch 48, it is studied in the block 50 whether the guide from FIGS. 1 to 2 is in a stable phase, i.e. no fatigue exists and the running-in phase is ended. If a stable phase is not provided, the running-in phase is thus recognized by the analysis device 8 according to FIG. 3 in block 52 and subsequently a new measurement is initiated in the block 54. The combined characteristic decreases during the running-in phase. If the characteristic remains equal, the block 56 provided in FIG. 3 thus follows after the block 50. The limits of the stable phase are adaptively adjusted therein if needed and a new measurement is subsequently initiated with the block 54.

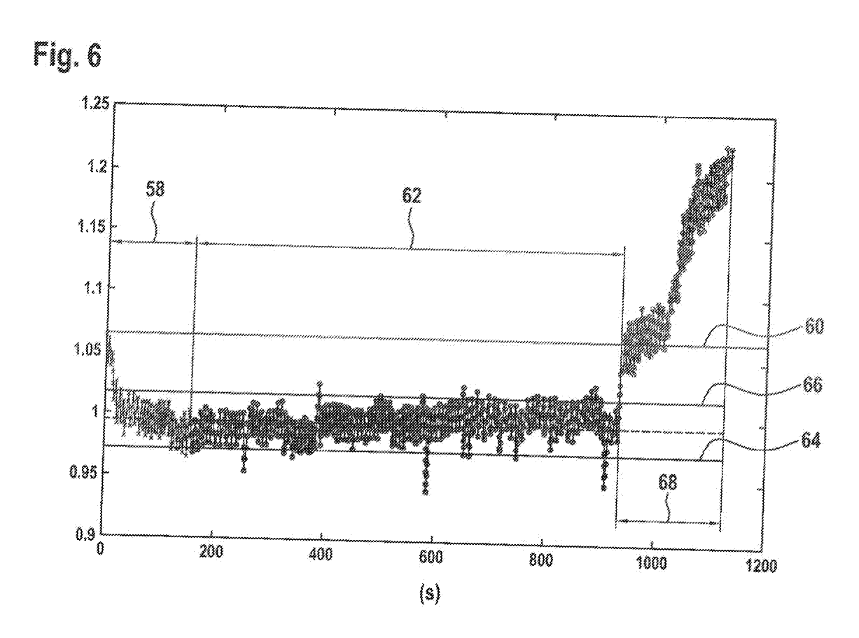

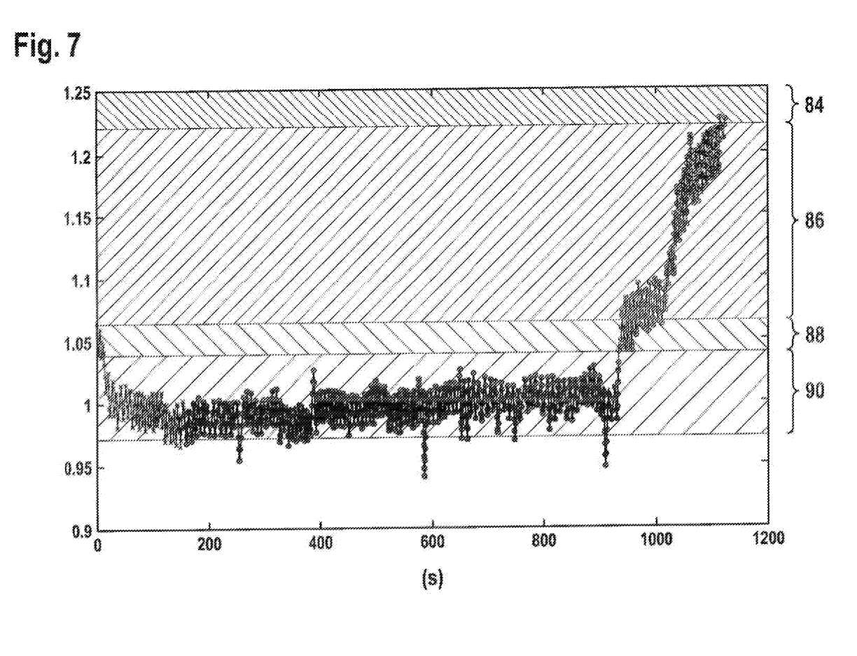

The determined combined characteristics are shown according to FIG. 6. The measurement number is shown on the abscissa and the scaled value of the combined characteristic is shown on the ordinate. It is recognizable in the running-in phase 58 that the combined characteristics sink proceeding from a starting level 60 of the running-in phase. Subsequently, a stable phase 62 takes place, in which the combined characteristics remain equal or remain approximately equal within adaptively changeable limits 64 and 66. If the combined characteristics increase, a fatigue phase 68 is thus recognized by the analysis device 8. This means if an increase of the combined characteristics is established in block 44 according to FIG. 3, the method is thus continued in the left branch 46. Firstly, it is established in block 69 whether the increase of the combined characteristic is greater than 56, i.e. it is established using statistical means whether an increase takes place. If this is not the case, an outlier counter is thus reduced by one point in block 70. The limits 64, 66 are subsequently again adaptively adjusted in the block 56, see FIG. 6. If the result of the statistical analysis in the block 69 is such that the increase of the combined characteristic is 56, in the block 72 the outlier counter is thus increased by one point. In the following block 74 it is then established whether the number of the outliers has exceeded a determined threshold value. If this is not the case, a new measurement is thus initiated in the block 54. However, if this is the case, it is thus determined in the block 46 whether the scaled value of the combined characteristic is greater than the starting level 60, see FIG. 6. If this is not the case, a warning level 1 is then output in the block 78. If this is the case, the check thus follows in the block 79 as to whether a limiting value is exceeded. The limiting value is, for example, an estimated remaining service life or an absolute threshold value or the limiting values listed in the introduction to the description. If the limiting value is exceeded, an alarm is then output in the block 80. If the limiting value is not exceeded, a warning level 2 is then output in the block 82. This is schematically shown in FIG. 7. In this case, the various warning levels and the alarm are shown based on FIG. 6. If the conditions explained according to FIG. 3 are fulfilled, an alarm is thus output in the range 84. A warning level 2 takes place in the range 86, a warning level 1 takes place in the range 88, and no warning or no alarm takes place in the range 90.

A sensor assembly, in particular for a guide, is provided according to the disclosure, which has a sensor and an analysis device. The analysis device determines a movement profile of the guide component based on a vibration signal detected by the sensor, wherein a part of the movement profile is used for fatigue detection. Alternatively or additionally, it can be provided that the vibration signal detected by the sensor is filtered or digitally filtered and the or a movement profile of the guide component is determined based on the filtered or digitally filtered signal.

### LIST OF REFERENCE NUMERALS

1 guide spindle
2 ballscrew nut
4; 16 housing
6 sensor
8 analysis device
10 energy generating unit
12 guide rail
14 guide carriage
18 end face
20 measurement
22 vibration signal
24, 36, 38, 40, 42, 44, 50, 52, 54, 56, 69, 70, 72, 74, 76, 78, 79, 80, 82 block
26 movement profile
28, 30, 32 curve
34 threshold value
46 left branch
48 right branch
58 running-in phase
60 starting level
62 stable phase
64, 66 limit
68 fatigue phase
84, 86, 88, 90 range

What is claimed is:

1. A guide comprising:
a guide part; and
a guide component configured to be guided and movable via the guide part,
wherein a sensor is configured to detect a vibration signal of the guide component,
wherein an analysis device is configured to analyze the vibration signal detected by the sensor, and
wherein the analysis device is configured to at least one of (i) determine a movement profile of the guide component based on the vibration signal detected by the sensor and perform fatigue detection using the vibration signal of a part of the movement profile, and (ii) digitally filter the vibration signal detected by the sensor and determine the movement profile of the guide component based on the digitally filtered vibration signal.

2. The guide according to claim 1, wherein the analysis device is configured to determine a frequency band of the vibration signal and perform fatigue detection using the frequency band.

3. The guide according to claim 1, wherein the analysis device is configured to digitally filter the vibration signal detected by the sensor via at least one of a low-pass filter and a discrete wavelet transformation.

4. The guide according to claim 1, wherein the analysis device is configured to determine at least one part of the movement profile of the guide component, the at least one part of the movement profile including at least one of a standstill profile, a starting profile, an acceleration profile, a profile of constant velocity, and a braking profile.

5. The guide according to claim 4, wherein the analysis device is configured to at least one of:
perform the fatigue detection in the profile of constant velocity; and
determine a velocity of the guide component based on the vibration signal.

6. The guide according to claim 5, wherein the analysis device is configured to determine the velocity based on at least one of the starting profile and the acceleration profile.

7. The guide according to claim 1, wherein the analysis device is configured to determine at least one characteristic in one of the determined frequency band and the vibration signal.

8. The guide according to claim 7, wherein at least one of:
the determined at least one characteristic includes at least one of a mean value, a mean absolute deviation (MAD), and a root mean square;
the analysis device is configured to scale the determined at least one characteristic using a determined velocity;
the analysis device is configured to, in the case that the at least one characteristic includes at least two characteristics, combine the at least two characteristics; and
the analysis device is configured to output at least one of a warning and an alarm in response to an increase of the at least one characteristic.

9. The guide according to claim 1, wherein one of:
the guide component is a guide carriage and the guide part is a guide rail, a housing, which has at least one of the sensor and the analysis device, being fixed on the guide carriage, the housing at least one of (i) being arranged on a side of the guide carriage facing in the longitudinal direction, (ii) enclosing the guide rail, (iii) partially encompassing the guide rail, and (iv) completely encompassing the guide rail; and
the guide component is a threaded nut and the guide part is a guide spindle, the housing, which has at least one of the sensor and the analysis device, being fixed on the threaded nut, the housing at least one of (i) being arranged axially on the threaded nut, (ii) enclosing the guide spindle, (iii) partially encompassing the guide spindle, and (iv) completely encompassing the guide spindle.

10. The guide according to claim 7, wherein:
the analysis device is configured to determine a slope of the at least one characteristic in comparison to at least one preceding value for the at least one characteristic; and
at least one of:
in response to the slope of the at least one characteristic being less than or equal to zero, the analysis device is configured to conclude that no fatigue is present;
in response to the slope of the at least one characteristic being approximately zero, the analysis device is configured to conclude the guide is in a stable phase; and
in response to the slope of the at least one characteristic being greater than zero, the analysis device is configured to conclude that fatigue is present in the guide.

11. The guide according to claim 7, wherein at least one of:
the analysis device is configured to output a first warning in response to the at least one characteristic exceeding an upper limit;
the analysis device is configured to output a second warning in response to a value of the at least one characteristic exceeding a maximum value of the at least one characteristic in one of (i) a running-in phase of the guide component, and (ii) at the beginning of recordings of the guide component; and
the analysis device is configured to output one of an alarm and a third warning in response to at least one condition being fulfilled, the at least one condition including at least one of (i) after the further warning, a predetermined number of cycles being reached, (ii) an estimated remaining service life being reached, (iii) the at least one characteristic exceeding a determined statistical limit, and (iv) one of an absolute limit, a configurable limit, and a threshold value for the at least one characteristic being reached.

12. The guide according to claim 7, wherein:
the analysis device is configured to presume a non-change of the at least one characteristic if it is at least one of (i) below an upper limit, (ii) above a lower limit, and (iii) between two limits; and
the analysis device is configured to compute and adaptively adjust at least one of (i) the upper limit, (ii) the lower limit, and (iii) the two limits using the at least one characteristic.

13. The guide according to claim 1, wherein the analysis device is configured to perform the fatigue detection in a location-resolved manner.

14. A sensor assembly for a guide having a guide part and a guide component configured to be guided and movable via the guide part, the sensor assembly comprising:
a sensor configured to detect a vibration signal of the guide component; and
an analysis device configured to analyze the vibration signal detected by the sensor, the analysis device being configured to determine a movement profile of the guide component based on the vibration signal detected by the sensor and perform fatigue detection using the vibration signal of a part of the movement profile

15. A method using a sensor assembly for a guide having a guide part and a guide component configured to be guided and movable via the guide part, the sensor assembly having a sensor configured to detect a vibration signal of the guide component and an analysis device configured to analyze the vibration signal detected by the sensor, the method comprising at least one of:
determining a movement profile of the guide component based on the vibration signal detected by the sensor and performing fatigue detection using the vibration signal of a part of the movement profile;
digitally filtering the vibration signal detected by the sensor and determining the movement profile of the guide component based on the digitally filtered vibration signal; and
determining a frequency band of the vibration signal and performing the fatigue detection using the frequency band.
